(19) United States
(12) Patent Application Publication
(10) Pub. No.: US 2026/0310697 A1
(43) Pub. Date: Oct. 8, 2026

(54) Document Processing for Frequently-Asked-Questions Detection in Natural Language Content

(71) Applicant: Pryon Incorporated, Raleigh, NC (US)

(72) Inventors: Carmi Rothberg, New York, NY (US); Soonthorn Ativanichayaphong, New York, NY (US); John Michael Pruitt, Seattle, WA (US); Etienne Marcheret, White Plains, NY (US)

(21) Appl. No.: 19/481,677

(22) PCT Filed: Apr. 30, 2024
(86) PCT No.: PCT/US2024/026989

§ 371 Date: Nov. 5, 2025

Related U.S. Application Data
(60) Provisional application No. 63/464,271, filed on May 5, 2023.

(51) Int. Cl. G06F 16/3329; G06F 16/383

(52) U.S. Cl. CPC G06F 16/33295; G06F 16/383

(57) ABSTRACT

Disclosed are methods, systems, devices, apparatus, media, and other implementations, including a method for processing a document comprising natural language content that includes identifying a question content portion of the document representing one or more questions, determining an answer content portion of the document corresponding to the one or more questions, and recording the question content portion and the corresponding answer content portion for use in responding to natural language queries.

### CROSS-REFERENCE TO RELATED APPLICATIONS

This application is an International Application that claims the benefit of U.S. Provisional Application No. 63/464,271, filed May 5, 2023, the contents of which are herein incorporated by reference in their entireties.

### BACKGROUND

The present invention relates to detection of frequently-asked-questions (FAQ) content in documents, and the resultant processing of detected FAQ content.

Question-answering searching platforms store searchable content that often has undergone some pre-processing (or ingestion). Examples of such pre-processing are segmentation (chunking) processing, in which source content is broken into smaller chunks of content. Subsequently, queries submitted to the platform are matched against the stored content (which may have been transformed into vector representation) that had been segmented during the pre-processing.

Segmenting content using a uniform chunk size, or other forms of indiscriminate segmenting, can thus cause related content to be split. This may result in imperfect matching of queries to answers. In situations where the source content includes passages that provide information in the form of question-and-answer, this type of indiscriminate segmenting can significantly hamper the searching process, since matching a submitted question to an already existing question-and-answer pair could have resulted in the question-and-answer pair being identified as having a high matching score. Instead, a query is matched against split portions of the question-answer content, likely resulting in lower matching scores.

### SUMMARY

In a broad aspect, the proposed framework is directed to FAQ identification (e.g., according to tags with a mark-up language source document). In some examples, a tree-like structures of content (e.g., HTML documents or other types of data arrangements, including Pryon Inc.'s document object model (DOM) elements) is converted into array-like structure. This allows for easier element-by-element processing, while preserving certain container elements (specifically, tables and lists). This process is referred to as HTML Flattening. HTML element boundaries are used to inform FAQ detection by treating each element as a unit that can potentially be a question, as well as using heading tags to identify the end of an answer.

In various examples, an identified Q-A pair within the content may be moved or reproduced within a dedicated FAQ listing, or it may itself already be part of a larger list of frequently asked questions.

Alternatively, the Q-A pair may be kept within a content file being processed, and tagged to indicate the existence and boundaries of a Q-A pair (to facilitate chunking and ingestion). In such embodiments, a document that does not have explicit markup tags to denote question answer pairs is processed (analyzed) to identify passages within the document that constitute Q-A pairs. Those identified Q-A pair passages can then each be jointly ingested (i.e., to produce a vector representation for the full text of each Q-A pair) which can later result in better matching queries to ingested content (because at least part of the transformed content was not arbitrarily segmented and/or transformed).

In some examples, the proposed framework can implement the identification of question-answer pairs in the document using a rules-based engine (e.g., algorithmically) and/or using a machine learning classification engine that can identify questions (e.g., based on their semantic meaning) and determine the relatedness of any follow-up sentences to an identified question (this is referred to as an entailment scheme).

In operation, a data processing and information retrieval system processes a document comprising natural language content. The system identifies a question content portion (according to a rules-based process, or according to a machine learning question detection model) of the document representing one or more questions, determines an answer content portion of the document (according to a rules-based process, or according to machine learning answer detection model) corresponding to the one or more questions, and records the question content portion and the corresponding answer content portion for use in responding to natural language queries. In identifying the question content portion and/or the corresponding answer content portion, the system uses at least one of, for example, markup data in the document, rendering and/or visual arrangement information in the document, and/or linguistic content of the document.

In an example involving processing of an HTML document, the system receives an input hierarchical data structure comprising the natural language content, formatting elements representative of formatting applied to the natural language content to render viewable output data, and tags representative of information descriptive of the natural language content. The system then performs a flattening process on the input hierarchical data structure to generate the document, with the flattening process including removing at least some of the formatting elements and tags, and identifying leaf node elements in the input hierarchical data structure. In such embodiments, recording the question content portion and corresponding answer content portion includes adding Q-A tags to detected question-answer content, the Q-A tags bounding a combined Q-A data segment comprising the identified question content portion and the determined answer content portion. Amongst the advantages of the flattening process is that it renders the resultant flattened document structure more readable for manual analysis and debugging.

The proposed framework detects during pre-processing and ingestion possible question-answer content that should be kept together or combined. By detecting the question-and-answer pairs, the framework can dynamically adjust its chunking processing so that related Q-A content is kept together (even if it does result in larger than normal chunk sizes), while other content continues to be processed according to the default processing procedures. The proposed framework can therefore achieve a more optimum balance in which content is generally split into manageable searchable chunks, but allowing variance from the general processing procedure for content that would provide a better match if kept together.

Thus, in some variations, a method is provided for processing a document comprising natural language content. The method includes identifying a question content portion of the document representing one or more questions, determining an answer content portion of the document corresponding to the one or more questions, and recording the question content portion and the corresponding answer content portion for use in responding to natural language queries.

In some variations, a system is provided that includes a communication unit to communicate with one or more remote computing devices, one or more storage devices to store content data and computer-executable instructions, and a processor-based controller electrically coupled to the communication unit and the one or more storage devices. The processor-based controller is configured to identify a question content portion representing one or more questions of a document comprising natural language content, determine an answer content portion of the document corresponding to the one or more questions, and record the question content portion and the corresponding answer content portion for use in responding to natural language queries.

In some variations, a non-transitory computer readable media is provided that is programmed with instructions, executable on one or more processors of a computing system, to identify a question content portion of the document representing one or more questions, determine an answer content portion of the document corresponding to the one or more questions, and record the question content portion and the corresponding answer content portion for use in responding to natural language queries.

Embodiments of any of the above method, system, and/or computer-readable media may include at least some of the features described in the present disclosure, and may be combined with any other embodiment or variation of the methods, systems, media, and other implementations described herein.

Other features and advantages of the invention are apparent from the following description, and from the claims.

### BRIEF DESCRIPTION OF THE DRAWINGS

These and other aspects will now be described in detail with reference to the following drawings.

FIG. 1 is a schematic diagram of the architecture of an example information retrieval system on which the techniques described herein can be implemented.

FIG. 2 is a flowchart of an example procedure for processing a document comprising natural language content.

FIG. 3 shows the architecture of a question-answering platform that relies on ingested documents that include question-answer clusters.

FIG. 4 is a flowchart of a method for processing the ingested documents of FIG. 3 to make use of question clusters.

Like reference symbols in the various drawings indicate like elements.

### DESCRIPTION

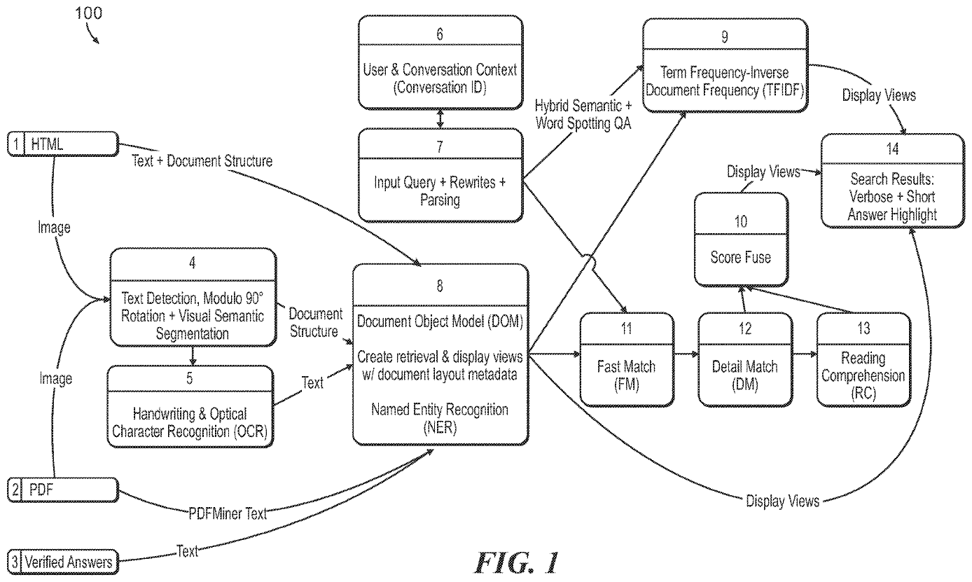

A number of embodiments to implement FAQ (frequently-asked-questions) detection are described. These implementations can be used in conjunction with implementations of the question-based document retrieval system described in WO 2021/263138, titled “DOCUMENT PROCESSING AND RESPONSE GENERATION SYSTEM,” published on Dec. 30, 2021, which is incorporated herein by reference. A schematic diagram of the architecture of an example information retrieval system on which the techniques described herein can be implemented (including FAQ detection based on, for example, identification of tags) is provided in FIG. 1.

The implementations described herein are premised on the idea that within a content document (in whatever format it may be) there may be a passage that includes attributes of a question (e.g., the passage ends with a question mark, or a sentence begins with an interrogative wording) which may be accompanied by content that may have attributes of an answer to a question. For example, consider a situation where you have a document and there are two paragraphs following each other. One paragraph is a one-sentence passage with a question mark after it. Following the question mark there is a one-sentence passage (before a new paragraph begins). The shortness of the passage following the sentence ending with a question mark may indicate that the one-sentence passage is an answer to the preceding question, thus making the identified question and one-sentence passage a potential Q-A embedded within the content. (In some embodiments, additional conditions, criteria, or rules may need to be met before passages can be more definitively determined to be a Q-A passage.)

The proposed framework seeks to treat these things in a more organized fashion to compile, from source documents, frequently asked questions. This can facilitate the practice, of many companies, to collect question-answer content to place them in a dedicated repository or database that can be accessed by authorized users when needed.

The proposed framework requires discovering what entails (constitutes) a paragraph, or any type of object or element in the content data being analyzed. In the example of an HTML document, the document includes a deeply nested structure (a tree-like structure) that includes ‘div’ tags on the page, and inside of the ‘divs’ there might be a heading and a paragraph and another paragraph. The processing/analysis of such an HTML document involves converting the nested structure of an HTML portion into a flattened array of like elements (e.g., into a sequence of element-element-element), and then examining each element to determine whether it meets criteria for a question. If it does, the framework deems an element meeting sufficient question criteria to be a question, and everything following that to be an answer, until another question, or some other type of element, is encountered that acts like a blocker to indicate the end of the answer. In various examples, the flattening process for HTML documents includes starting at the beginning of a data arrangement, and going down the data arrangement (traversing the arrangement) to each leaf node (what is considered a leaf node may depend on the particular rules that are applied to deem a particular element as a leaf node). Each leaf node can then be added to a leaf node list.

In some embodiments, the rules for identifying leaf nodes may be such that individual paragraphs can be considered to be leaf nodes. A list of items may be considered, in other embodiments, to be a leaf node (a list can act as a container with multiple items inside of it). When traversing/scanning content data, elements such as hierarchy tags, or formatting codes (bold or italic) may not, in some embodiments, considered to be elements that are added to the leaf node list, even though those might be inside a paragraph.

Having compiled a list of leaf nodes, the next step may be to figure out which of the elements on the list correspond to questions (and/or answers). The flattening process can be thought of as generating simplified HTML, that in turn makes the resultant flattened content simplified (more readable, and with fewer tags or formatting elements) to thus simplify the question and answer detection process within the flattened / simplified content.

The flattening process thus results, in some embodiments, in a simplified document in which at least some of the hierarchical formatting and tagging elements of an input source (e.g., HTML document) are removed and/or various elements (leaf nodes, which may be actual content passages) are arranged in a simpler way to process a simplified document based on which question and answer content elements can be identified. As noted, the question and answer elements may then be detected based on a potentially complex set of rules. The detection process produces an outcome/output in which question and answer elements are separated from other content elements (also referred to as authored content). The separation of content into Q-A pairs and other types of content types can be useful in hybrid documents to identify portions that are already formatted as Q-A pairs since subsequent searches, on a question-answering information retrieval system, will be matched more easily to the Q-A pairs that were in the original content (because the submitted query/question could then more easily be matched to the question and answer in the Q-A pairs included in the content). Identifying content portion that are Q-A pairs could improve subsequent searching performance (e.g., accuracy). Furthermore, given the high relevance of Q-A pair to subsequent question-answering searches, during ingestion Q-A pairs identified in content data can be ingested as combined chunks. In such embodiments, regular chunking rules (e.g., chunking / segmenting raw content into chunks of 200 words) may be suspended, and instead ingesting (e.g., using some language model transform such as BERT) may be applied to a larger chunk resulting from combining an identified question and its identified answer.

An improvement realized by the proposed framework is the idea that at least some of the tags should be considered when determining whether an end point of an answer portion (associated with an earlier question portion) has been reached. If only raw content (paragraphs) is used to determine the end of an answer, it is not always clear when the end point has been reached. Consider a situation where the content data includes a heading, which is a question, and then there is a paragraph, which is an answer, followed by another (second) heading, which is not a question. There is a high likelihood that the second heading ends the first answer. So knowing that another heading has been reached is a useful marker (like something that would be noticed visually). The identification of the second heading, in this case, serves as indicator that the end of the paragraph, preceding the second heading that was detected, is the end of the answer to the question that was detected.

To illustrate the Q-A detection, and/or FAQ compilation process (e.g., how to detect what these Frequently Asked Questions are and how to organize them), consider an example in which a complex hierarchical document (e.g., HTML document) is processed by the proposed approach. First, at least some of hierarchical elements (tags, such as div and span tags, and formatting elements (italicizing, bolding, etc.)) may be removed/excluded. This can be performed by scanning the document for leaf node elements (the actual readable content that would be viewed and read by a user) and arranging the leaf node elements in a list. The resultant list represents a simplified HTML document in which readable content (or at least some of it) has been preserved, optionally with some of tags and formatting elements that were not excluded. When the simplified HTML document is scanned, assume that the fifth element in the document includes a question mark at its end. This may indicate to the process that a question has been identified. The process continues scanning the content, and encounters a heading, indicating (according to one of the rules used for identifying questions and answers) that the end of the preceding passage (before the heading) was the end of the answer portion to the identified question. This is an example of one possible rule in which, after identifying a question, you remain at the tier of the passages following the question until the document transitions to a higher tier (e.g., as indicated by the heading that is encountered).

Having identified a question passage and its corresponding answer passage(s), the resultant document (e.g., a simplified HTML document into which the complex hierarchical source document was flattened) is revised to tag (e.g., with simplified HTML tags) the identified question and answer portions. Thus, in this example embodiments, upon the identification of a question-answer pair within the content data, the question-answer pair is not removed and placed into a separate FAQ file, but rather the question-pair is tagged as part of a mechanism to treat that content portion differently from non-question-answer portions. Then, upon ingestion of the document/file now containing the identified and tagged question-answer pair, the segmentation (or chunking) window on which vector transformations (and/or other processing and ingestion procedures) are performed can be adjusted so as to capture the entirety of the tagged question-answer pair, instead of some default chunking size (e.g., 200 words).

The framework may be implemented by identifying content segments meeting certain conditions or criteria, analyzing content and formatting information (e.g., HTML tags) indicative of location boundaries (within the content being examined/analyzed) of where answer content to an identified question resides.

In some embodiments, identification of either question portions of answer portions with the data being analyzed may be performed, at least in part, using one or more trained machine learning models that are configured to analyze data segments (e.g., a paragraph, or part of a paragraph) to determine if the paragraph is either a question (even if it does not include a question mark at the end of the paragraph), or an answer (following the identification of a question within the content data). The machine learning (ML) engines may be implemented according to any machine learning architecture that can receive as input content data, and output a classification (or label) indicating whether the data is a question or an answer of a Q-A pair within the content. Such ML architecture may be based on transforming the input data into vector-based representations that represent the semantic meaning of the input data.

The ML answer engine can determine if a data segment, following a segment determined to be a question, is an answer to the question by determining relatedness (also referred to as entailment) of the segment determined to be question and a data segment that follows the question (and can thus potentially be part of the answer to the question). Put another way, under this implementation, a machine learning entailment engine would determine whether a sentence that follows (immediately, or farther down) a string of words ending in a question mark is logically connected to the string of words ending in the question mark). Here too, the comparison of data segments to assess their relatedness (the entailment of a follow-up sentence to be an answer of an earlier identified question) may be performed by transforming input data into vector representations, or through any other ML implementation or architecture. It is to be noted that the use of machine learning engines to identify questions and answers can be used in place of or in addition to a rules-based procedure to identify questions and answers.

An ML entailment implementation may be configured to assess whether, upon detection of a potential question in the content data (e.g., due to detection of a question mark in a data segment), the text around it (following it) is related to something else. For example, a paragraph determined to include a question may be a rhetorical question, and thus may not be part of an FAQ pair (e.g., the passage immediately following the question is unrelated to the question, and the identified question does not really get answered by the next sentence).

In embodiments in which a determination is made that a sentence(s) that follow a portion of the document determined to include a question are not related to that question, that knowledge can assist the subsequent segmentation (chunking) of the source content during document ingestion. That is, if a document may generally be segmented into 200-word chunks for non-Q-A (non-FAQ) content, the knowledge that two sequential text portions, of which one is a question, are not related, allows the ingestion engine to ingest those two analyzed portion separately even if they would otherwise have been combined (or partly combined) through the default 200-word segmentation. The determination that two sequential text portions are not related and should be ingested separately is also referred to as semantic segmentation.

The proposed framework tries to find a balance for the dilemma arising from ingestion of content. If the system ingests very large pieces of content, the matching to those large pieces becomes challenging. On the other hand, if the system ingests pieces that are too small, the matching process might yield good results, but context could be missing from the ingested content. The idea behind layout segmentation and semantic segmentation (as described herein) is to hit the appropriate size. That is, if a passage can be determined (based on layout) to be an FAQ item/element, and some parts of the identified passage can be uncoupled if those parts are determined to not be semantically related to the question portion (based on semantic segmentation), then the appropriate ingestion size (which may vary for different parts of the document) can be determined.

Through the proposed framework, an HTML document (or other types of documents) can be canvassed to identify FAQ passages, and can also find a balance between mixing content together, processing chunks of content that really have only one related answer (with less related content decoupled, or separated, from the FAQ). The balancing of chunk size (through layout segmentation with or without semantic segmentation) improves the likelihood of less ambiguous matching. In some embodiments, even text following a question that is related to an identified question but does not immediately follow the question may be separated (to facilitate ingestion of smaller chunks), but may be later joined with the question using, for example, clustering methods (to break things into pieces and then stitch them together at a later point). In some embodiments, stitching separated passages to an earlier identified question may be done a sentence at a time to create a larger contiguous passage, until you reach a point where matching performance starts degrading (e.g., making the passage too large causes matching scores to queries to become worse).

While the proposed framework has been described as being used to identify and process Q-A pairs (FAQs) within a document, the framework can be used to identify other content elements, and more broadly be used to detect topic or subject matter changes. The framework may also be used to identify non-contiguous, but related passages (e.g., passages at different pages of the document that nevertheless are related to some topic, in a way that might warrant re-positioning one of the related passage to be contiguous with the other passages).

Thus, implementations of the proposed framework include a system including a communication unit to communicate with one or more remote computing devices, one or more storage devices to store content data and computer-executable instructions, and a processor-based controller electrically coupled to the communication unit and the one or more storage devices. The processor-based controller is configured to identify a question content portion representing one or more questions of a document comprising natural language content, determine an answer content portion of the document corresponding to the one or more questions, and record the question content portion and the corresponding answer content portion for use in responding to natural language queries.

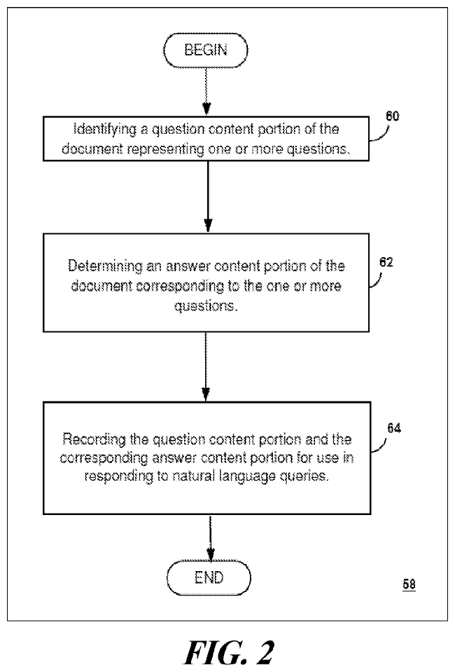

With reference to FIG. 2, a flowchart of an example procedure 200 for processing a document comprising natural language content is provided. The procedure 200 includes identifying 210 a question content portion of the document representing one or more questions, determining 220 an answer content portion of the document corresponding to the one or more questions, and recording the question content portion and the corresponding answer content portion for use in responding to natural language queries.

Identifying of the question content portion and/or the corresponding answer content portion may use at least one of markup data in the document, rendering and/or visual arrangement information in the document, and linguistic content of the document. In various examples, determining the answer content portion of the document may include determining a start point for the answer content portion of the document following the question content portion, and determining an end point of the answer content portion, including analyzing one or more data portions following the determined start point of the answer content portion, and determining for each of the analyzed one or more data portions whether it satisfies one or more conditions indicating an ending of the answer content portion.

The procedure 200 may further include receiving an input hierarchical data structure comprising the natural language content, formatting elements representative of formatting applied to the natural language content to render viewable output data, and tags representative of information descriptive of the natural language content, and performing a flattening process on the input hierarchical data structure to generate the document. The flattening process may include removing at least some of the formatting elements and tags, and identifying leaf node elements in the input hierarchical data structure. In such examples, the document may include an ordered listing of the identified leaf node elements, the ordered listing excluding the removed at least some of the formatting elements and the tags. Identifying leaf node elements may include identifying content data elements, wherein the content data elements include content passages.

In various examples, recording the question content portion and corresponding answer content portion may include adding Q-A tags to detected question-answer content, with the Q-A tags bounding a combined Q-A data segment comprising the identified question content portion and the determined answer content portion. In such examples, the procedure may further include ingesting the document to transform segments of the content data into vector representations according to a language model transform. Ingesting the data arrangement may include segmenting the content data into chunks that include the combined data segment bounded by the Q-A tags, and one or more additional chunks comprising one or more of: a uniform sized chunks containing non-Q-A data, or a variable sized chunks containing Q-A data, and applying the language model transform to combined data segment and separately to each of the one or more additional chunks.

Identifying the question content portion may include identifying the question content portion using a trained machine learning question model configured to determine whether a first data segment of the natural language content is a question of a Q-A pair. Determining the answer content portion may include identifying the answer content portion using a trained machine learning answer model configured to determine whether a subsequent data segment following the identified question content portion is an answer portion of the Q-A pair. In such embodiments, identifying the answer content portion using the trained machine learning answer model may include determining, using the machine learning answer model, semantic relatedness of the subsequent data segment to the first data segment.

In implementations described herein that are based on learning machines, different types of learning architectures, configurations, and/or implementation approaches may be used. Examples of learning machines include neural networks, including convolutional neural network (CNN), feed-forward neural networks, recurrent neural networks (RNN), etc. Feed-forward networks include one or more layers of nodes (“neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration / structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), etc.

The neural networks (and other network configurations and implementations for realizing the various procedures and operations described herein) can be implemented on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's, which can be programmed according to, for example, a CUDA C platform), and may also include special purpose logic circuitry, e.g., an FPGA (field programmable gate array), an ASIC (application-specific integrated circuit), a DSP processor, an accelerated processing unit (APU), an application processor, customized dedicated circuity, etc., to implement, at least in part, the processes and functionality for the neural network, processes, and methods described herein. The computing platforms used to implement the neural networks typically also include memory for storing data and software instructions for executing programmed functionality within the device. Generally speaking, a computer accessible storage medium may include any non-transitory storage media accessible by a computer during use to provide instructions and/or data to the computer. For example, a computer accessible storage medium may include storage media such as magnetic or optical disks and semiconductor (solid-state) memories, DRAM, SRAM, etc.

The various learning processes implemented through use of the neural networks described herein may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, etc.

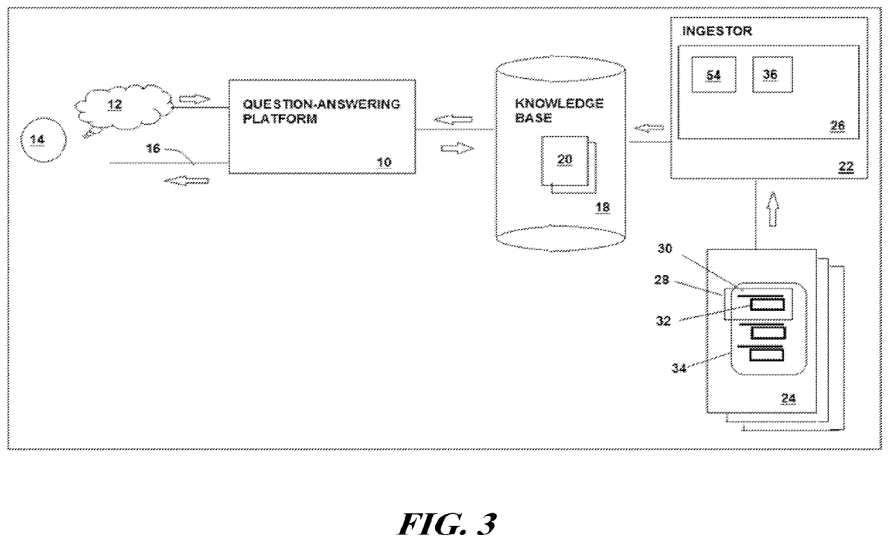

FIG. 3 shows an embodiment of a question-based document retrieval system, or “question-answering platform”, 10 of a type introduced above. This system receives a natural-language user query 12 from a user 14 and provides a query response 16 to that user query 12. The question-answering platform 10 uses a knowledge base 18 that comprises a variety of ingested documents 20. An ingestor 22 carries out an ingestion process for producing these ingested documents 20 includes certain pre-processing steps to enhance their usefulness in responding to queries 12.

In operation, the question-answering platform 10 analyzes the user query 12. After having done so, it identifies one or more portions of the ingested documents 20 that include information for answering the user query 12. It then provides these identified portions to the user 14. These form the basis for the question-answering platform's query response 16 to the user query 12.

The ingestor 22 begins with a population of source documents 24. The source documents 24 run the gamut from user manuals, in-house memoranda, publications, and so forth. The ingestor 22 applies an ingestion process 26 to each of these source documents 24. The result is the population of corresponding ingested documents 20.

In some cases, there exist one or more source documents 24 that include question-answer pairs 28. Each question-answer pair 28 includes a question 30 and its corresponding answer 32. In some cases, these question-answer pairs 28 are grouped together to form question-answer-pair clusters 34, referred to herein as simply “clusters 34” for brevity.

A cluster 34 in a source document 24 typically arises from editorial decisions made by authors of the source document 24. These editorial decisions are grounded in the editors' recognition that there exist frequently-asked questions 30 and that it is efficient to gather these frequently-asked questions 30 and their corresponding answers 32 in one place to promote accessibility by readers.

When an original document 20 includes a cluster 34, it is typical to provide visual cues to assist a reader in identifying the cluster 34.

These cues are often typographic in nature. Examples include headings that text such as “FAQ” or “Frequently-Asked Questions.” Other cues are more subtle cues, such as paragraphs of alternating format, with a first paragraph in a first format being followed by one or more second paragraphs having a second format. In such cases, the first format indicates a question 30 and the second format indicates its answer 32.

Other visual cues include those that arise from punctuation. For example, a paragraph that ends in a question mark is likely to be a question 30. A paragraph that immediately follows that paragraph and that ends in a full stop is likely to be an answer 32 to that question 30. The first paragraph and the one or more paragraphs that follow would thus define a question-answer pair 28.

In other cases, the visual cue is an alphanumeric character that precedes a question 30 and another alphanumeric character that precedes its answer 32. Examples include “Q” and “A,” respectively.

Other cues for identifying a cluster 34 are of a more distinctly semantic nature. For example, there exist certain combinations of words that impart interrogative intent.

Such words define interrogative content. The presence of interrogative content in content is indicative of that content being a question. Examples of this are, of course, highly language dependent. In the English language, they would include passages having an inversion of subject and verb or an initial word such as “does,” “where,” “when” and the like.

In a question-answering platform 10, question-answer clusters 34 are exceptionally useful for answering queries. After all, they represent the fruit of editorial decisions made specifically to enable the reader to easily find answers 32 to those questions 30 that, as a result of editorial experience, have been found to be the most frequently asked questions 30. A question-answering platform 10 having an ingestor 22 as described herein leverages these editorial decisions by identifying such question-answer clusters 34 so that they can be used when delivering answers 32 to queries. This type of segmentation of a source document 24, which relies heavily on document layout, is referred to as “layout segmentation.”

In some embodiments, question-answer clusters 34 are placed in a dedicated repository or database that can be accessed by users 14 when needed. However, in other embodiments, question-answer clusters 34 are simply tagged and retained within the document 20.

In some cases, the nature of the original document 20 offers additional clues for finding question-answer clusters 34. For example, certain source documents 20, such as those prepared in a hyper-text markup language, incorporate a tree-like structure in which there exist tags that define the location of a region of the document within that document's tree structure. An example of such a tag is a “DIV” tag. Because of their tree-like structure, these source documents 20 are often called “hierarchical documents.”

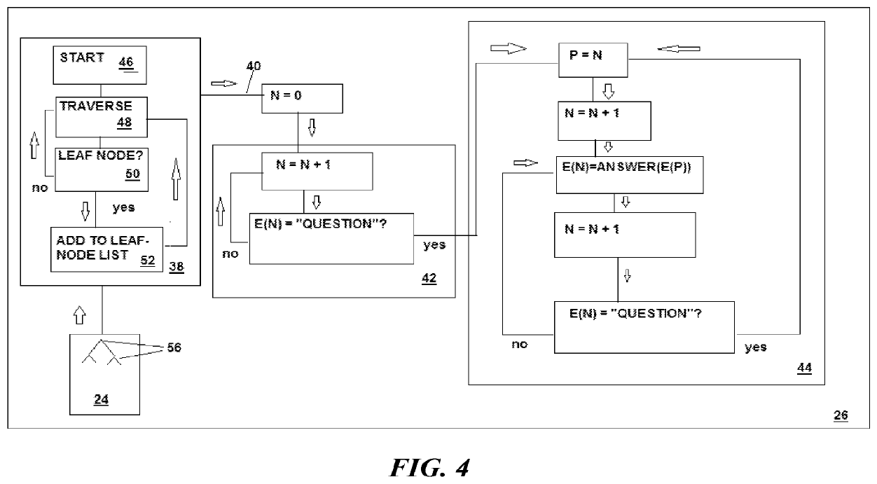

Referring now to FIG. 4, the ingestor 22 executes a cluster-identification process 36 for identifying question-answer clusters 34 in a hierarchical document 20.

The cluster-identification process 36 includes a flattening process 38 to convert the document's tree structure into a flattened array of elements. The result is a flattened document 40.

The cluster-identification process 36 then examines a first element of the flattened document 40 to determine whether it satisfied the criteria for being a question 30 (step 42).

Upon determining that that the first element is a question 30, the cluster-identification process 36 regards all elements that follow that first element and that are not themselves questions 30 as being constituent elements of an answer 32 to the question 30 posed by the first element (step 44).

In various examples, the flattening process 38 for a tree-structured document 20 includes starting at the document's beginning (step 46), traversing its tree structure (step 48). Upon encountering a leaf node (step 50), the flattening process 38 adds that leaf node to a leaf-node list (step 52).

Whether the flattening process 38 classifies a node in a tree-structured document 20 as a leaf node or not will depend on application-specific rules that are applied for implementing such a classification. In some embodiments, the flattening process 38 considers individual paragraphs to be leaf nodes. In other embodiments, the flattening process 38 considers a list of items to be a leaf node. In such embodiments, the flattening process 38 treats a list as a container that contains multiple items within it.

When traversing the hierarchical document 20, the flattening process 38 avoids incorporating extraneous matter in a list of leaf nodes even if that extraneous matter happens to be within a paragraph. Examples of such extraneous matter include tags that identify a level of the hierarchy or tags that control formatting of text.

The resulting flattened document 40 has fewer tags or formatting elements that might otherwise impede the process of identifying questions 30 and their corresponding answers 32. In particular, the flattening process 38 removes various hierarchical tags and formatting tags. This makes it possible to identify question clusters 34 more easily and with greater reliability. In many cases, the flattened document's leaf nodes comprise textual passages.

Having compiled a list of leaf nodes, the cluster-identification process 36 proceeds to identify those elements on the list of leaf nodes that possess features that, when considered as a whole, are sufficient to consider those elements as being “questions 30” (step 42) and those elements on the list of leaf nodes that possess features that are sufficient to consider those elements as “answers 32” to those questions 30 (step 44).

In some embodiments, cluster-identification process 36 also separates question-answer clusters 34 from the remainder of the document 20. Such separation results in a knowledge base 18 in which certain ones of the ingested documents 20, referred to herein as “hybrid documents,” have been optimized to be more easily matched to particular queries 12.

The ingestion process 26 typically includes a chunking process 54 that divides an original document 20 into equal-sized chunks for storage in the knowledge base 18. since the chunks are of equal size, they are independent of semantic content. Examples of a chunking process 54 include those that, during ingestion, places a chunk boundary after some fixed number of words, without regard to the meanings of those words. Many chunking processes 54 divide the document 20 into chunks of two-hundred words.

The recognition and use of question-answer clusters 34 greatly improves searching performance, including the speed at which an answer 32 can be retrieved and its accuracy. It is therefore useful to provide a chunking process 54 that suspends default chunking rules upon having identified a question-answer cluster 34 that has been designated as such by the cluster-identification process 36. This makes it possible to ensure that the entire question-answer cluster 34 will ultimately lie within one chunk. In a preferred embodiment, it is also useful for the chunking process 54 to place nothing but question-answer pairs 28 within such a chunk.

A chunking process 54 that has been improved in this manner is configured to ingest using a different process, such as by using a language model transform, such as BERT, with the objective of ensuring that a question-answer pair 28 from the source document 24 will ultimately reside in the same chunk within the ingested document 20 in the knowledge base 18 and that nothing but question-answer pairs 28 resides in this chunk.

A preferred chunking process 54 also adds a “question” label to any chunk that comprises a question-answer pair 28 and includes the text of the question as metadata associated with that label. Doing so may offers advantages including the following.

The first advantage is the ability to match the user query 12 against the question 30 by itself, isolated within the metadata, and to use a different model for that match, which may result in a matching weight that differs from that which would have resulted if the user query 12 were matched against the ingested document 20 itself.

The second advantage arises during the display of the query response 16 to the user 14. During such a display, it is usual to highlight the text that the platform 10 regards as most relevant. It is quite possible, especially if the user query 12 and the question 30 are very similar, for the platform 10 to highlight the text of the question 30. This would be of little interest to the user 14.

By using a label with the question's text as metadata, it is possible to assign a retrieval weight and a highlight weight separately. The similarity of the user query 12 to the text of the question 30 results in a high retrieval weight that causes the platform 10 to retrieve the question-answer pair 28 for presentation to the user 14. However, in doing so, the platform 10 assigns the greater highlight weight to the answer 32 instead of to the question 30. This results in a query response 16 with more appropriate highlighting.

Some methods use tags within a document 20 as a basis for determining the bounds of an answer 32 that corresponds to a particular question 30. This offers advantages over simply using raw content as a basis for determining when an answer 32 has ended.

A simple example of using tags within a document 20 is one in which the cluster-identification process 36 is configured to determine the bounds of an answer 32 upon recognizing that a question 30 has been tagged with a first tag and that the answer 32 has been tagged with a second tag. In such cases, the cluster-identification process 36 assumes, from a transition away from the second tag, that the answer 32 has come to an end.

In a particular example, the flattening process 38 receives a hierarchical document 24 in which tags 56 define tiers of a hierarchy. An example of such a hierarchical document 24 is a hypertext markup language document 24. A hypertext markup language document 24 often includes hierarchical tags 56, such as the “DIV” and “SPAN” tags, as well as formatting tags, such as those that define whether characters are to be rendered in bold or italics.

The flattening process 38 creates a flattened document 40 from the hierarchical document 24 by removing unnecessary tags 56 and scanning the original document for its leaf node elements. These contain the readable content that a human user would actually be able to see. The flattening process 38 then creates a list of leaf nodes. The result is a flattened document 40 that preserves at least some readable content from the original hierarchical document 24 and any tags 56 retained by the flattening process 38.

The flattening process 38 then scans the flattened document 40 to identify features that indicate whether a particular leaf node is a question 30, an answer 32, or neither. An example of such a feature that implies that a leaf node contains a question 30 is a question mark at the end of the text of that leaf node.

The flattening process 38 continues scanning the flattened document's content until it encounters a heading. It then applies, to that heading, a rule for identifying question 30 and answers 32. Upon determining that the heading indicates an answer 32, the flattening process 38 assumes that the end of the passage following that heading is the end of the answer 32 to the most recently identified question 30. This is a special case of a rule that causes the flattening process 38 to remain in the same tier after identifying a question 30 until the document transitions to a higher tier, e.g., as indicated by the heading that the flattening process 38 encounters.

After having identified a question 30 and its corresponding answer 32, the ingestor 22 revises the foregoing flattened document 40 by tagging the identified question 30 and its corresponding answer 32, thus defining a question-answer pair 28 within the ingested document 20 itself.

An important feature of this method is that there is no need to place the question-answer pair 28 into a separate file. It simply remains with the ingested document 20 but with question-answer tags that indicate that it should be treated differently from those portions of the document 20 that are not part of a question-answer pair 28.

In particular, when the ingestor 22 executes the chunking process 54 on the flattened document 40, the question-answer tags signal the chunking process 54 to override the rule for dividing an source document 24 into equal-sized chunks to the extent needed to keep the question-answer pair 28, and preferably the entire question-answer cluster 34 of which it may be a part, within the same chunk in the knowledge base 18.

Implementations of the cluster-identification process 36 include those that rely on identifying particular segments of a document's content that meet certain conditions, those that analyze the content of the document, and those that analyze formatting information, such as tags, including tags that indicate boundaries between question 30 and answers 32.

Some implementations identify question clusters 34 using machine-learning models instead of rules. Such models are trained to identify questions 30 and answers 32 thereto, including questions 30 that omit question marks. Such machine-learning models include those implemented by a machine-learning architecture that receives the document's content as input and that provides, as an output, information that classifies the input as part of a question-answer pair 28 or as a question cluster 34 that comprises many question-answer pairs 28. Examples of such machine-learning architecture include those that transform input data into a vector-based representation of the semantic content of that input data.

In some embodiments, the machine-learning answer-engine comprises an entailment engine that determines whether content that follows a question 30 answers that question 30. It does so by determining relatedness or entailment of that content to that question 30. In some embodiments, the entailment engine determines whether text that follows a string of words that ends in a question mark, whether successively or otherwise, is logically connected to that string of words. Among these embodiments are those in which input to the entailment engine comprises vector representations of semantic content of text.

Other embodiments use a combination of machine learning and rules to identify questions 30 and their corresponding answers 32.

Embodiments that rely on an entailment engine include those that assess whether, upon detection of a potential question in a document 20, neighboring text relates to something other than the question. This often arises when a document includes a rhetorical question.

As noted above, it is desirable for a chunk that contains question-answer pairs 28 to avoid having any extraneous content within it. Such extraneous content can sometimes arise between a question 30 and its corresponding answer 32 or between question-answer pairs 28 in a cluster 34.

In some embodiments, the chunking process 54 out semantic segmentation. It does so by recognizing the existence of a question 30 followed by content that is unrelated to the question 30. Upon encountering this situation, the chunking process 54 causes these to be ingested in separate chunks.

A chunking process 54 that carries out both source segmentation and layout segmentation provides a significant advantage. When ingesting a source document 24, the size of the chunks has an effect on the quality of a query response 16 and the ability to match a user query 12 to a relevant portion of a document.

When chunk size is large, the process of matching a user query 12 to a relevant chunk of an ingested document 20 is harder. On the other hand, a successful match means presentation of a large chunk, which means that a great deal of context will be provided in the query response 16. Conversely, for small chunk sizes, the process of matching a user query 12 to a chunk becomes easier. But presentation of a small chunk means that the query response 16 will have only minimal content.

The ability to carry out both layout segmentation and semantic segmentation results in the ability to have adaptive chunk sizes that can be optimized for matching and for supplying an appropriate quantity of context in the query response 16. For example, a chunking process 54 is able that uses layout segmentation to identify a cluster 34 will cause the cluster 34 to be within one chunk. But it may also allow extraneous content to be swept into the same chunk in the process. On the other hand, by also carrying out semantic segmentation, the chunking process 54 will be able to filter out extraneous material and thus purify the chunk so that it holds only a cluster 34. This permits the chunk size to vary depending on the content of the source document 24.

In some cases, the source document 24 has a question 30 and an answer 32 separated by irrelevant text. To address this difficulty, certain embodiments of the chunking process 54 will break the source document 24 into pieces and stitch it back together so that the answer 32 becomes closer to the question 30. This makes it possible to place the question-answer pair 28 in a chunk that is smaller than it would have to otherwise be to accommodate the extraneous text, thereby avoiding an unnecessarily large chunk. In cases of a multi-sentence answer 32, the chunking process 54 is able to stitch the answer 32 one sentence at a time, stopping only when the matching performance begins to degrade as a result of lengthening the answer 32.

The ingestor 22 has been described as being used to identify and process question-answer pairs 28 within a source document 24. However, since the ingestor 22 is ultimately looking for features common to particular types of content, the principles described herein are applicable to identifying other types of content and causing the chunking process 54 to adaptively vary chunk size and distribution of content within chunks based on having identified such features. For example, the principles described herein are useful for detecting changes in subject matter of the content. The principles described herein are also useful for identifying non-contiguous but related passages, such as passages at different pages of the source document 24 that are nevertheless related to the same topic and stitching these related passages together to form one contiguous passage that relates to the particular topic.

In some embodiments, the procedure 50 includes a flattening process 38 that flattens a source document 24 that has a hierarchical data structure that comprises a combination of natural-language content, formatting elements representative of formatting applied to the natural-language content to render viewable output data, and tags and performing a flattening process 38 to generate an ingested document 20.

Embodiments of such a flattening process 38 include those that remove one or more formatting elements and tags and that identify leaf nodes in the source document's hierarchical data structure. In such examples, the ingested document 20 includes an ordered listing of the identified leaf nodes. This ordered listing omits formatting elements and tags found in the source document 24. Embodiments of the flattening process 38 include those that identify leaf nodes by identifying textual in the source document 24.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Although particular embodiments have been disclosed herein in detail, this has been done by way of example for purposes of illustration only, and is not intended to be limit the scope of the invention, which is defined by the scope of the appended claims.

Any of the features of the disclosed embodiments described herein can be combined with each other, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

1. A method for processing a document comprising natural language content, the method comprising:
identifying a question content portion of the document representing one or more questions;
determining a answer content portion of the document corresponding to the one or more questions; and
recording a correspondence of the question content portion and the answer content portion for use in responding to natural language queries.

2. The method of claim 1, wherein identifying of the question content portion and/or the answer content portion uses at least one of markup data in the document, rendering and/or visual arrangement information in the document, and linguistic content of the document.

3. The method of claim 1, wherein determining the answer content portion of the document comprises:
determining a start point for the answer content portion of the document following the question content portion; and
determining an end point of the answer content portion, including
analyzing one or more data portions following the start point of the answer content portion, and
determining for each of the one or more data portions whether it satisfies one or more conditions indicating an ending of the answer content portion.

4. The method of claim 1, further comprising:
receiving an input hierarchical data structure comprising the natural language content, formatting elements representative of formatting applied to the natural language content to render viewable output data, and tags representative of information descriptive of the natural language content; and
performing a flattening process on the input hierarchical data structure to generate the document, the flattening process including:
removing at least some of the formatting elements and tags, and
identifying leaf node elements in the input hierarchical data structure.

5. The method of claim 4, wherein the document includes an ordered listing of the leaf node elements identified in the input hierarchical data structure, the ordered listing excluding the at least some of the formatting elements and tags.

6. The method of claim 4, wherein identifying the leaf node elements comprises identifying content data elements, wherein the content data elements include content passages.

7. The method of claim 4, wherein recording the question content portion and corresponding answer content portion comprises: adding Q-A tags to detected question-answer content, the Q-A tags bounding a combined Q-A data segment comprising the question content portion and the answer content portion.

8. The method of claim 7, further comprising:
ingesting the document to transform segments of the natural language content into vector representations according to a language model transform, wherein ingesting the document includes
segmenting the natural language content into chunks that include a combined data segment bounded by the Q-A tags, and one or more additional chunks comprising one or more of: a uniform sized chunks containing non-Q-A data, or a variable sized chunks containing Q-A data, and
applying the language model transform to combined data segment and separately to each of the one or more additional chunks.

9. The method of claim 1, wherein identifying the question content portion comprises identifying the question content portion using a trained machine learning question model configured to determine whether a first data segment of the natural language content is a question of a Q-A pair, and wherein determining the answer content portion comprises identifying the answer content portion using a trained machine learning answer model configured to determine whether a subsequent data segment following the question content portion is an answer portion of the Q-A pair.

10. The method of claim 9, wherein identifying the answer content portion using the trained machine learning answer model comprises determining, using the trained machine learning answer model, semantic relatedness of the subsequent data segment to the first data segment.

11. The method of claim 1, wherein the document is a first source document that is one of a plurality of source documents—each of which comprises natural-language content, and wherein the method further comprises:
constructing a knowledge base, the knowledge base comprising ingested documents, the ingested documents resulting from an ingestor having ingested the plurality of source documents;
receiving a user query; and
using the knowledge base to provide a query response to the user query;
wherein constructing the knowledge base comprises causing the ingestor to carry out steps of
identifying a question in the question content portion of the first source document,
identifying an answer in the answer content portion of the first source document,
determining that the answer answers the question, and
wherein recording the correspondence of the question content portion and the answer content portion for use in responding to the natural language queries comprises recording an association between the question and the answer, the association defining the question and the answer as constituents of a question-answer pair; and
using a question-answering platform to provide a query response to the user query including
determining that the user query matches the question,
based on the association, determining that the question is a constituent of a question-answer pair,
retrieving the answer from the question-answer pair, and
providing the answer as a constituent part of the query response.

12. The method of claim 11, where identifying the question in the natural language content comprises:
identifying markup data in the first source document;
determining that the markup data is applicable to a portion of the natural language content; and
based at least in part on having determined that the markup data is applicable to a portion of the natural language content, identifying the portion of the first source document as possessing interrogative content.

13. The method of claim 11, where identifying the question in the content comprises:
identifying a visual arrangement of a portion of the source document; and
based at least in part on having identified the visual arrangement, identifying the portion as comprising interrogative content.

14. The method of claim 11, where identifying the question in the content comprises using semantic content of the source document to determine that a portion of the content in the source document comprises interrogative content.

15. The method of claim 11, where identifying the answer in the content comprises:
identifying markup data in the source document;
determining that the markup data applies to a portion of the content in the source document; and
based at least in part on the determination, identifying the portion of the content as being responsive to interrogative content.

16. The method of claim 11, where identifying the answer in the content comprises:
observing a visual arrangement of features of a portion of the source document; and
based at least in part on the observation, identifying the portion of the content as being responsive to interrogative content.

17. The method of claim 11, where identifying the answer in the content comprises using semantic content of the source document to determine that a portion of the content is responsive to interrogative content.

18. The method of claim 11, where identifying the answer in the content comprises:
making a first determination;
making a second determination; and
based at least in part on having made the first determination and having made the second determination, determining that the content is responsive to interrogative content;
wherein the first determination comprises determining that a chunk of text follows a question mark; and
wherein the second determination comprises determining that the chunk of text ends in a full stop.

19. The method of claim 11, wherein identifying the answer in the content comprises using information determined from having identified the question in the content.

20. The method of claim 11, wherein identifying the answer in the content comprises:
after having identified the question, determining a start point of a first answer and determining an end point of the first answer;
analyzing data that follows the start point of the first answer; and
determining that the data that follows the start point indicates an end point for the first answer;
wherein the start point is a point in the content at which the first answer begins,
wherein there exist no other answers between the question and the first answer, and
wherein there exist no other questions between the question and the first answer.

21. The method of claim 11, wherein identifying the answer in the content comprises, after having identified the question, determining a start point of a first answer and determining an end point of the first answer, analyzing data that follows the start point of the first answer, and determining that the data that follows the start point indicates an end point for the first answer, wherein the start point is a point in the content at which the first answer begins. and
wherein a second answer follows the end point.

22. The method of claim 11, further comprising:
determining that the first source document is a hierarchical document; and
generating a flattened document based on the first source document;
wherein identifying the question comprises using the flattened document to determine that a first portion of the content comprises interrogative content, and
wherein identifying the answer comprises using the flattened document to determine that a second portion of the content is responsive to the interrogative content in the first portion.

23. The method of claim 11, further comprising:
determining that the first source document comprises tags that define a hierarchy in the content of the first source document;
wherein identifying the question comprises using the tags to identify a first portion of the content as comprising interrogative content, and
wherein identifying the answer comprises using the tags to identify a second portion of the content as being responsive to the interrogative content in the first portion.

24. The method of claim 11, further comprising determining that the first source document comprises tags that define a tree that ends in leaf nodes and removing selected tags from the first source document, thereby reducing a depth of the leaf nodes in the tree and wherein identifying the question and the answer comprises using the leaf nodes to identify interrogative content and content responsive to the interrogative content, respectively.

25. The method of claim 11, further comprising determining that the first source document comprises tags, among which are tags that define a tree that ends in leaf nodes and removing selected tags from the first source document and constructing an ordered list of the leaf nodes, wherein the ordered list excludes selected ones of the tags.

26. The method of claim 11, further comprising determining that the first source document comprises tags, among which are tags that define a tree that ends in leaf nodes and wherein the leaf nodes comprise text.

27. The method of claim 11, wherein recording the association that defines the question and the answer as constituents of the question-answer pair comprises adding question-answer tags to mark the question and the answer, wherein the question-answer tags bound the question-answer pair.

28. The method of claim 11, wherein ingesting source documents comprises causing a chunking process to divide the first source document into chunks,
wherein causing the chunking process to divide the first source document into chunks comprises causing the chunking process to adjust a size of at least one of the chunks to avoid having the question and the answer in different chunks in the ingested documents, whereby the question-answer pair is contained in a particular chunk.

29. The method of claim 11, wherein ingesting source documents comprises:
transforming segments of the content into vector representations according to a language model transform;
using the vector representations to mark the question-answer pair; and
causing a chunking process to place the question-answer pair entirely within a particular chunk in the ingested documents.

30. The method of claim 11, determining that the answer in the content of the first source document answers the question in the content of the first document comprises:
determining a model that has been trained to determine that content that follows interrogative content in a source document is responsive to the interrogative content;
using the model to process the first source document; and
receiving, from the model, output indicative of the answer being responsive to the question;
wherein recording the association between the question and the question's answer is carried out based at least in part on the output from the model.

31. The method of claim 11, wherein determining that the answer in the content of the first source document answers the question in the content of the first document comprises:
determining a model that has been trained to recognize a semantic relationship between first and second portions of content in a natural-language document;
applying the model to the first source document; and
receiving, from the trained model, output indicating that a first portion of the first source document is responsive to interrogative content in a second portion of the source document, the second portion having been identified as the question;
wherein recording the association comprises recording the association based at least in part on the output of the model.

32. The method of claim 11, wherein the ingestor is configured to divide the source documents into chunks when ingesting the source documents, wherein the method further comprises determining that the question-answer pair is one of a plurality of question-answer pairs in a cluster of question-answer pairs and wherein the ingestor is configured to divide the source documents into chunks in a way that ensures that the cluster is within a chunk.

33. A system comprising:
a communication unit to communicate with one or more remote computing devices;
one or more storage devices to store content data and computer-executable instructions; and
a processor-based controller electrically coupled to the communication unit and the one or more storage devices, the processor-based controller configured to
identify a question content portion representing one or more questions of a document comprising natural language content,
determine an answer content portion of the document corresponding to the one or more questions, and
record the question content portion and the corresponding answer content portion for use in responding to natural language queries.

34. A non-transitory computer readable media programmed with instructions, executable on one or more processors of a computing system, to:
identify a question content portion of a document representing one or more questions;
determine an answer content portion of the document corresponding to the one or more questions; and
record the question content portion and the corresponding answer content portion for use in responding to natural language queries.
